(19) United States
(12) Patent Application Publication
(10) Pub. No.: US 2024/0112145 A1
(43) Pub. Date: Apr. 4, 2024

(54) DYNAMIC CONTENT PERSONALIZATION WITHIN A TRAINING PLATFORM

(71) Applicant: EasyLlama Inc., Walnut, CA (US)

(72) Inventors: Michael Serge Devyver, Palo Alto, CA (US); Samuel Alexis Devyver, Mountain View, CA (US)

(21) Appl. No.: 17/958,414

(22) Filed: Oct. 2, 2022

(51) Int. Cl. G06Q 10/10; G09B 5/06; G09B 7/08

(52) U.S. Cl. CPC G06Q 10/1053; G09B 5/06; G09B 7/08

(57) ABSTRACT

Methods and systems provide for dynamic content personalization within a training platform. The system connects a client device to a training platform, with the client device being associated with an employee of an organization; determines that custom organization content is associated with the organization within the training platform; receives at least a subset of the custom organization content and at least a content type for each piece of custom organization content; and presents, to the client device, a UI for a training module selected for employees of the organization, the UI including one or more custom organization elements alongside a plurality of training elements, with each of the custom organization elements incorporating one or more pieces of the custom organization content.

### FIELD OF INVENTION

The present invention relates generally to compliance training, and more particularly, to systems and methods for providing dynamic content personalization within a training platform.

### BACKGROUND

Compliance training has increasingly become an essential component of the modern workplace, and in many contexts and regions throughout the world, companies are required to ensure such training has been completed on an ongoing basis. Compliance training refers to the process of educating employees within an organization on laws, regulations, and company policies that apply to their day-to-day job responsibilities. Organizations which engage in compliance training typically seek to accomplish several goals, such as: avoiding and detecting violations by employees that could lead to legal liability for the organization; creating a more hospitable and respectful workplace; laying the groundwork for a partial or complete defense in the event that employee wrongdoing occurs despite the organization's training efforts; and adding business value as well as a competitive advantage. Compliance training can relate to a wide range of topics, including, e.g., training on workplace harassment and discrimination, diversity and inclusion, the Health Insurance Portability and Accountability Act (“HIPAA”), cybersecurity, human trafficking (for hotel organizations, for example), unconscious bias training, the Occupational Safety and Health Administration (“OSHA”), and more.

One common way of conducting compliance training is via a training platform, which may often be implemented with a learning management system (“LMS”). A “compliance LMS” has a feature set which allows it to carry out compliance-focused training programs, using, e.g., automated processes, accurate collection of data and metrics, monitoring and reporting of the data and metrics, certification upon completion of training, and more. Products and services for compliance training conducted via such training platforms has become a specialized industry in itself.

While compliance LMSes have become increasingly sophisticated, they still largely lack the ability of an organization to customize and tailor content, aesthetics, and specifics of the training being offered to their employees specifically. For example, there is no ability to insert an employee's actual coworkers in her department into training scenarios. Doing so would make the training lessons much more “personalized”, and would provide an increased relevancy and significance to employees far above the current offerings for training scenarios and narratives, which often require employees to think about issues and problems which are faced by fictional characters the employee is not invested in.

Thus, there is a need in the field of compliance training to create new and useful systems and methods for providing dynamic content personalization within a training platform. The inventors have identified an absence in the current field of art of the ability to provide custom organization content specific to an organization which can be incorporated into elements of training modules which are accessed by employees of that organization.

### BRIEF DESCRIPTION OF THE DRAWINGS

The present invention relates generally to digital communication, and more particularly, to systems and methods providing for dynamic alteration of notification preferences within a training platform.

The present disclosure will become better understood from the detailed description and the drawings, wherein:

FIG. 1A is a diagram illustrating an exemplary environment in which some embodiments may operate.

FIG. 1B is a diagram illustrating an exemplary computer system that may execute instructions to perform some of the methods herein.

FIG. 2 is a flow chart illustrating an exemplary method that may be performed in some embodiments.

FIG. 3 is a diagram illustrating one example embodiment of a user interface (“UP”) for a training module being presented to an employee in which custom organization content has been incorporated.

FIG. 4A is a diagram illustrating one example embodiment of a UI allowing an administrator for an organization to submit custom organization content.

FIG. 4B is a diagram illustrating one example embodiment of a UI for a training module being presented to an employee with custom organization elements incorporating custom organization content.

FIG. 5 is a diagram illustrating one example embodiment of a UI for a training module being presented to an employee with custom organization elements incorporating custom organization content.

FIG. 6 is a diagram illustrating an exemplary computer that may perform processing in some embodiments.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

In one embodiment, the system connects a client device to a training platform, with the client device being associated with an employee of an organization; determines that custom organization content is associated with the organization within the training platform; receives at least a subset of the custom organization content and at least a content type for each piece of custom organization content; and presents, to the client device, a UI for a training module selected for employees of the organization, the UI including one or more custom organization elements alongside a plurality of training elements, with each of the custom organization elements incorporating one or more pieces of the custom organization content.

Further areas of applicability of the present disclosure will become apparent from the remainder of the detailed description, the claims, and the drawings. The detailed description and specific examples are intended for illustration only and are not intended to limit the scope of the disclosure.

I. Exemplary Environments

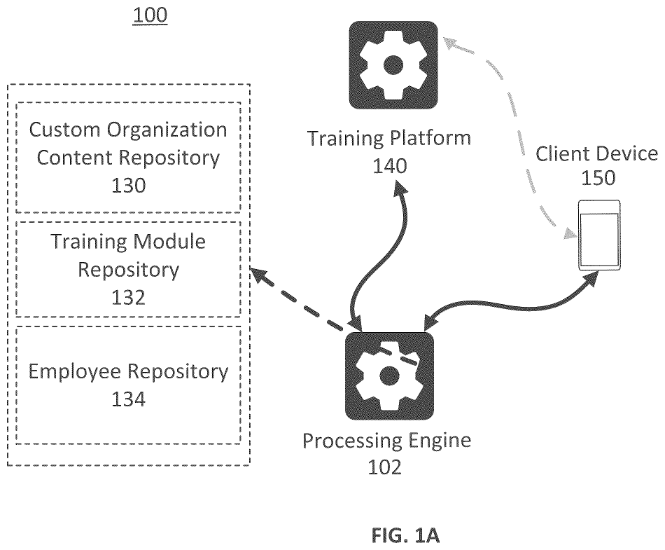

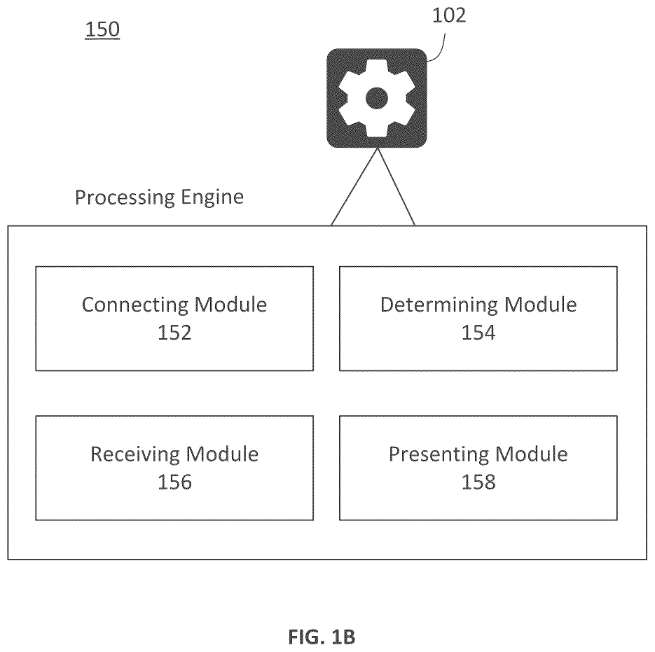

FIG. 1A is a diagram illustrating an exemplary environment in which some embodiments may operate. In the exemplary environment 100, an employee's client device 150 is connected to a processing engine 102 and, optionally, a training platform 140. The processing engine 102 is connected to the training platform 140, and optionally connected to one or more repositories and/or databases, including, e.g., a custom organization content repository 130, training module repository 132, and/or an employee repository 134. One or more of the databases may be combined or split into multiple databases. The client device 150 in this environment may be a computer, and the training platform 140 and processing engine 102 may be applications or software hosted on a computer or multiple computers which are communicatively coupled via remote server or locally.

The exemplary environment 100 is illustrated with only one client device, one processing engine, and one training platform, though in practice there may be more or fewer additional client devices, processing engines, and/or training platforms. In some embodiments, the client device(s), processing engine, and/or training platform may be part of the same computer or device.

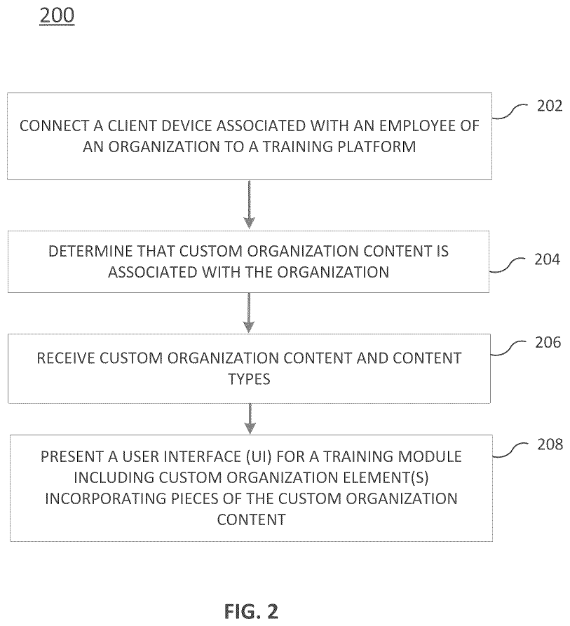

In an embodiment, the processing engine 102 may perform the exemplary method of FIG. 2 or other method herein and, as a result, provide for dynamic content personalization within a training platform. In some embodiments, this may be accomplished via communication with the employee's client device, processing engine, training platform, and/or other device(s) over a network between the device(s) and an application server or some other network server. In some embodiments, the processing engine 102 is an application, browser extension, or other piece of software hosted on a computer or similar device, or is itself a computer or similar device configured to host an application, browser extension, or other piece of software to perform some of the methods and embodiments herein.

The client device 150 is a device with a display configured to present information to a user of the device. In some embodiments, the user of the device is an employee of an organization (e.g., a for-profit enterprise, non-profit organization, etc.). In some embodiments, the client device presents, on an attached, embedded, or connected display, information in the form of a UI with multiple selectable UI elements or components. In some embodiments, the client device 150 is configured to send and receive signals and/or information to the processing engine 102 and/or training platform 140. In some embodiments, the client device is a computing device capable of hosting and executing one or more applications or other programs capable of sending and/or receiving information. In some embodiments, the client device may be a computer desktop or laptop, mobile phone, virtual assistant, virtual reality or augmented reality device, wearable, or any other suitable device capable of sending and receiving information. In some embodiments, the processing engine 102 and/or training platform 140 may be hosted in whole or in part as an application or web service executed on the client device 150. In some embodiments, one or more of the training platform 140, processing engine 102, and client device 150 may be the same device.

In some embodiments, optional repositories can include one or more of custom organization content repository 130, training module repository 132, and/or employee repository 134. The optional repositories function to store and/or maintain, respectively, custom organization content which has been submitted by an authorized individual to be associated with an organization; training modules within the training platform which may be accessible by employees of the organization; and a repository of employees, including employee information such as, e.g., demographic information, names, titles, and/or departments. The optional database(s) may also store and/or maintain any other suitable information for the processing engine 102 or training platform 140 to perform elements of the methods and systems herein. In some embodiments, the optional database(s) can be queried by one or more components of system 100 (e.g., by the processing engine 102), and specific stored data in the database(s) can be retrieved.

Training platform 140 is a platform configured to provide training modules and training courses to employees of an organization. In some embodiments, training platform 140 is implemented via an LMS architecture. For example, an LMS authoring tool may be used to establish the training platform, build training modules to be accessed, receive and keep track of relevant data and metrics, and more.

FIG. 1B is a diagram illustrating an exemplary computer system 150 with software modules that may execute some of the functionality described herein.

Connecting module 152 functions to connect a client device to a training platform, with the client device being associated with an employee of an organization.

Determining module 154 functions to determine that custom organization content is associated with the organization within the training platform.

Receiving module 156 functions to receive at least a subset of the custom organization content and at least a content type for each piece of custom organization content.

Presenting module 158 functions to present, to the client device, a UI for a training module selected for employees of the organization, the UI including one or more custom organization elements alongside a plurality of training elements, with each of the custom organization elements incorporating one or more pieces of the custom organization content.

The above modules and their functions will be described in further detail in relation to an exemplary method below.

II. Exemplary Method

FIG. 2 is a flow chart illustrating an exemplary method that may be performed in some embodiments.

At step 202, the system connects a client device to a training platform, with the client device being associated with an employee of an organization.

In some embodiments, the client device is associated with a user account on the training platform that is associated with the employee of the organization. For example, the employee may own and operate the client device, which may be, e.g., a smartphone or a laptop. The organization may have provided the employee with a user account on the training platform in order to allow the employee to complete compliance training modules as required by the organization's compliance policies. The employee uses their personal client device to sign into the account on the training platform, and the client device is connected to the training platform.

In some embodiments, connecting the client device to the training platform comprises authorizing and authenticating the client device within the training platform. For example, the training platform may perform some steps to ensure that the operator of the client device matches with the identity of the user account owner, or matches with the employee of the organization, and that there are no problems with authenticating or matching identities during this process. In some embodiments, the system may prompt the user of the client device for authentication information, such as a username and password, and potentially ask the user to perform, e.g., one or more two-factor authentication steps.

At step 204, the system determines that custom organization content is associated with the organization within the training platform. In some embodiments, this determination is performed by the system to ascertain whether the organization has any custom organization content present within the training platform. Such custom organization content may be submitted by an authorized administrator account for the organization, for example, via a submission UI presented to that administrator.

In various embodiments, the custom organization content can include one or more of: text, audio, images, video, narration, and interactive elements. For example, custom organization content for a particular organization may simply include the names and titles of employees, i.e., text content. In another example, custom organization content may also include photographs of employees. In yet another example, custom organization content can include a custom audio narration for a training module that is specific to the needs of the organization, and can also include a custom quiz to replace a default quiz included with a training module, with some interactive elements for submitting answers to the quiz and receiving results.

In some embodiments, the system performs the determination of step 204 by querying one or more databases where custom organization content may be stored and maintained for that particular organization. In other embodiments, the system may perform one or more rules-based procedures for determining whether content provided by the organization to the training platform may be custom organization content intended to be used for personalization of one or more training modules, or is instead information that is not intended to be used for personalization. In some embodiments, one or more pieces of metadata corresponding to pieces of content may provide an indication on whether the content is intended for personalization.

In some embodiments, using one or more pieces of custom organization content within the video module includes verifying that an employee associated with that content has given opt-in consent for the custom organization content to be used. In some embodiments, the system performs a check on whether the employee associated with the client device has opted in, opted out, or has not responded on consenting to the user of custom organization content which may be, in some way, personally identifying of the employee. If the employee has not opted in, then the custom organization content is determined to exist but is determined to not be available for personalization purposes.

In some embodiments, the system deploys an artificial intelligence (“AI”) model to determine that custom organization content is associated with the organization. In some embodiments, the deployed AI model may include AI-based processes and techniques, such as, e.g., machine learning (“ML”) or deep learning. In some embodiments, the AI model utilizes neural networks, such as, e.g., convolutional neural networks (“CNNs”), recurrent neural networks (“RNNs”) long short term memory (“LSTM”), and deep neural networks (“DNNs”). In some embodiments, the AI model can be trained on datasets relating to, e.g., previous custom organization content of the organization; previous or current custom organization content of other organizations within the communication platform; and more. In some embodiments, the AI model is trained to predict a classification for whether a given piece of content is to be treated as custom organization content for customizing training modules, or is instead information or content which is not to be used for personalization.

At step 206, the system receives at least a subset of the custom organization content and at least a content type for each piece of custom organization content. For example, at least a subset may mean that only one piece of custom organization content and its associated content type is received, or it may instead mean that all available pieces of custom organization content are received. In some embodiments, the amount of custom organization content received is determined by first receiving information on which training modules are to be loaded for the user, or which training modules have been assigned to the user that the user has not yet completed. In some embodiments, upon determining this information, the system can then receive the custom organization content with a content type that corresponds to needed content types for personalization of those training modules.

In some embodiments, at least one piece of the custom organization content relates to an industry classification for the organization. For example, the industry of the organization may be designated to be, e.g., information technology, legal services, textile manufacturing, construction services, hotel services, or any other industry designation as appropriate or relevant.

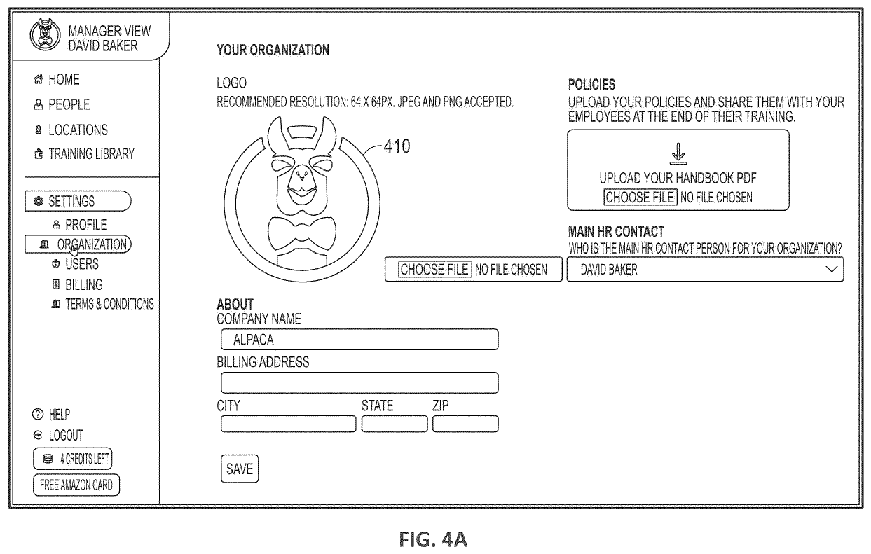

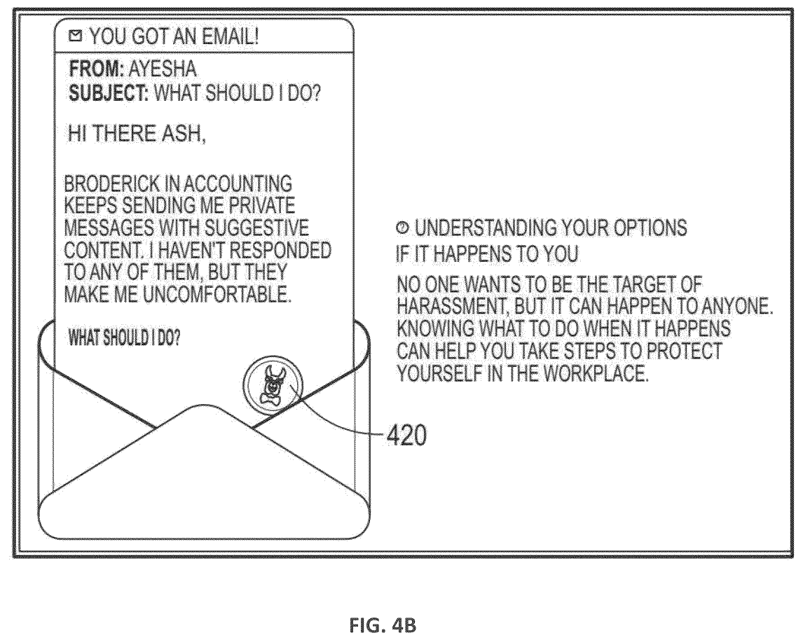

In some embodiments, at least one piece of the custom organization content relates to an organization logo. In some embodiments, a UI may be presented to an authorized administrator for the organization, with the UI allowing the administrator to upload a graphic file containing a logo for the organization. One example of an organization logo being submitted as custom organization content within such a UI will be described in further detail below with respect to FIG. 4A.

In some embodiments, at least one piece of the custom organization content relates to an organization background image. For example, an organization may designate or submit some content that contains a custom background image that depicts an interior view of the headquarters of the organization. This may then be incorporated into a background of a video actor in one of the training modules, in order to provide employees of the organization an impression that the actor is speaking from within the organization's headquarters. In some embodiments, at least one piece of the custom organization content relates to an industry background image, rather than or in addition to an organization background image. In some embodiments, an industry background image may be selected by or designated for an organization after the organization provides information about which industry it is to be classified under. An organization in the hotel services industry may have a backdrop of a lavish hotel lobby as one of the backgrounds for video actors in a training video, for example.

In some embodiments, at least one piece of the custom organization content relates to an organization color scheme. That is, an organization may select, designate, submit, or otherwise define one or more specific colors which are aligned with the organization's brand. Those customized colors can then be incorporated into a training module in various ways to present an employee with a training experience that provides the same color scheme as the organization itself consistently uses. In various embodiments, different colors may be additionally or alternatively used based on, for example, the demographic information of the employee in question, the time of day (e.g., present “dark mode” colors which are less bright and easier on the eyes during evenings), and any other suitable reason for selection of colors.

In some embodiments, at least one piece of the custom organization content relates to an organizational structure for the employees of the organization. This may provide context for, e.g., the employee's colleagues, supervisors, superiors, a team the employee belongs to or manages, and more. The organizational structure may additionally provide titles and/or departments for employees of the organization, which can then be stored within an employee repository and retrieved as custom organization content as needed for personalization.

In some embodiments, at least a subset of the custom organization content relates to one or more of: names, titles, and departments of the employees within the organization. In some embodiments, this employee information may be used to, e.g., substitute names of the employee or the employee's coworkers in for generic names within the training module; add employee titles to the training module for additional relevance during training scenarios; or may place characters in a training scenario in the same group or department based on information about the department placements of employees.

In some embodiments, at least a subset of the custom organization elements relate to a playback speed of audio narration within the training module. In some embodiments, custom organization elements can include a designation of a particular playback speed with which audio narration is to be played back in the training module. For example, some organizations may prefer a reasonably slow, relaxed narration, while others would prefer a faster narration.

In some embodiments, at least a subset of the custom organization elements relate to one or more of a custom narrator or a vocal tone of audio narration within the training module. For example, an organization may wish to use a custom narrator to provide custom narration for some or all of the text of a particular training module, or may wish to replace both the narrator and the text of a training module, either to modify the text or to substitute entirely new text. In another example, an organization may to specify or assign a different available vocal tone for a particular piece of audio narration, if multiple options for vocal tones are available.

In some embodiments, at least a subset of the custom organization elements comprise names used within training scenarios, where names of coworkers of the employee are incorporated into those custom organization elements. For example, names of coworkers on the employee's direct team may be used to illustrate a hypothetical scenario, with a prompt to the employee to decide which action to take. This provides a more immersive and directly relatable hypothetical scenario in a training module.

In some embodiments, at least a subset of the custom organization elements comprise images of people used within training scenarios, where images of coworkers of the employee are incorporated into those custom organization elements. For example, a stock image of a woman in a training module may be replaced by a custom organization element of a coworker of the employee who sits adjacent to the employee at the office environment where they work. An organization may wish to replace all such stock images with real employees. This may be done, e.g., randomly, based on organizational structure, based on department or team, or by any other relevant method.

In some embodiments, at least a subset of the custom organization elements relate to dynamically generated video, where a name, likeness, or other identifying content of an employee may be used within the dynamically generated video. In some embodiments, one or more videos in a training module may be algorithmically generated, such as, e.g., so-called “deepfake” videos consisting of a convincing, but not authentic video of a person talking. In some embodiments, with a particular employee's opt-in consent, his or her likeness, voice, face, and/or other elements may be used as custom organization content to generate such videos for use in training modules. In some embodiments, the video is dynamically generating using one or more AI techniques, such as, e.g., ML or deep learning.

In some embodiments, at least a subset of the custom organization elements includes custom training scenarios, where custom organization content relating to custom training scenarios for the organization are incorporated into the custom organization elements. For example, an organization may opt to replace one or more of the default training scenarios within a training module with custom training scenarios which are specific and relevant to that organization in particular.

In some embodiments, the system receives custom organization content via a payroll provider for the organization. That is, the system connects to a payroll provider for the organization; verifies one or more permissions with the payroll provider to receive custom organization content related to the organization; and receives custom organization content related to the organization from the payroll provider. In some embodiments, the received custom organization content from the payroll provider relates to one or more of: demographic information, names, titles, and departments about the employees of the organization.

At step 208, the system presents, to the client device, a UI for a training module selected for employees of the organization, the UI including one or more custom organization elements alongside a plurality of training elements, with each of the custom organization elements incorporating one or more pieces of the custom organization content.

In some embodiments, each of the custom organization elements comprise information on one or more content types to be incorporated into the custom organization element.

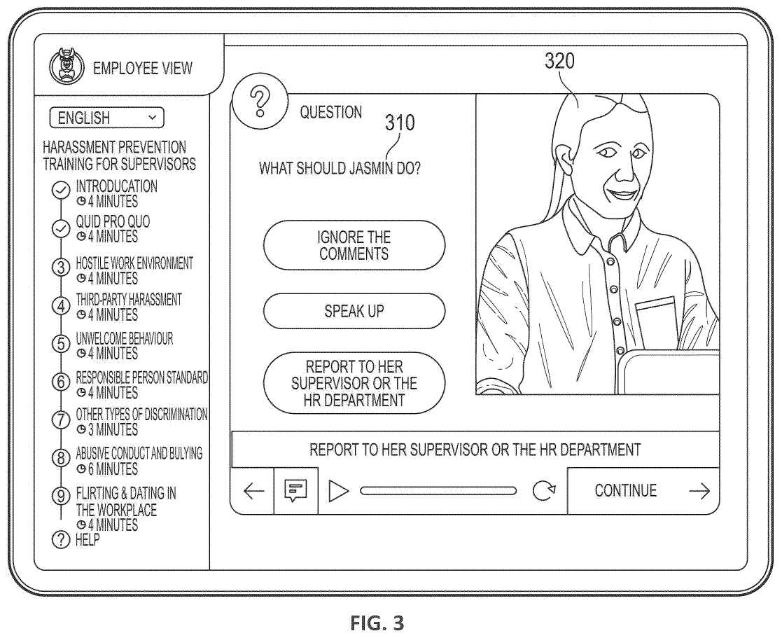

FIG. 3 is a diagram illustrating one example embodiment of a user interface (“UP”) for a training module being presented to an employee in which custom organization content has been incorporated.

Within the example embodiment, a screenshot of a training platform is displayed on a client device associated with a user. The screenshot presents a UI to the user of the client device. Within the UI, an “Employee View” for a training module is shown, representing a view that an employee of an organization would see for the particular training module being presented. On the left, a side panel shows a list of topics with estimated times for the employee to complete the content for those topics. To the right of that side panel, a primary window is presented. A question asks, “What should Jasmin do?”, and presents three choices which the employee may select from. Within the question, “Jasmin” represents custom organization content 310 which is associated with the organization. It has been incorporated into the slot where a name should be used for a training scenario being presented to the employee. The custom organization element is the slot where a name is to be filled in. The question could be thought of as equivalent to “What should X do?”, where X is the custom organization element to be replaced with a name. The name Jasmin has been incorporated in this instance because the organization's employee directory metadata, which includes such employees as Jasmin, has been associated with the organization within the training platform. In some cases the organization may, e.g., submit the directory with employee information to the training platform, while in other cases the training platform may request such information from the organization, or infer such information from the organization's account within the training platform. For example, a number of employees may be associated with the organization in such a way that the training platform receives information that those users are employees of the organization. In some cases, the employee name used, such as Jasmin, is selected for incorporation because Jasmin is an employee working within the same team, department, or office section as the employee who is in the process of completing the training module.

To the right of the question in the primary window, an image of a person is presented in a frame. This represents custom organization content 320 pertaining to an employee image, which has been incorporated into a custom organization element in that particular frame where an employee's image is to be incorporated. In this case, the training platform has received employee image data for an employee directory of the organization, and has located an employee directory photo of Jasmin to be incorporated. Thus, both Jasmin's name and Jasmin's photo may be used within a hypothetical training scenario in the training module.

FIG. 4A is a diagram illustrating one example embodiment of a UI allowing an administrator for an organization to submit custom organization content.

Within the example embodiment, a UI with a “Manager View” is presented. This “Manager View” UI displays options for an organization to add custom organization content to its user account on the training platform. Such custom organization content may provide the organization with the ability to personalize elements of the training platform to its specific details and content, such as, e.g., for personalizing training modules with custom content specific to that organization. Within a primary window of the UI, a “Logo” section is presented, where a representative or administrator of the organization may upload a custom image representing a logo for the organization. Once the organization has uploaded the custom image, it is displayed as a visual logo 410 within the UI, and can be used as custom organization content which may be incorporated into one or more custom organization elements within a training module.

FIG. 4B is a diagram illustrating one example embodiment of a UI for a training module being presented to an employee with custom organization elements incorporating custom organization content.

In the example embodiment, the visual logo 410 which was uploaded and presented in FIG. 4A now reappears as visual logo 420 within a UI presented to an employee of the organization who is in the process of completing a training module. Within the training module, a custom organization element is presented within a mock email, where the organization's visual logo can be incorporated as custom organization content. In this instance, the visual logo appears slightly rotated to fit into the visual theme in the UI of a “stamp” on a letter representing the email. In addition to the visual logo as a custom organization element, the names Ayesha, Ash, and Broderick also appear. These may be custom organization elements as well, which can be filled in with, e.g., the name of an organization employee in the same department as the employee completing the training module (Ayesha), the name of an organization employee in a different department from the employee completing the training module (Broderick), and the name of the employee completing the training module (Ash), respectively.

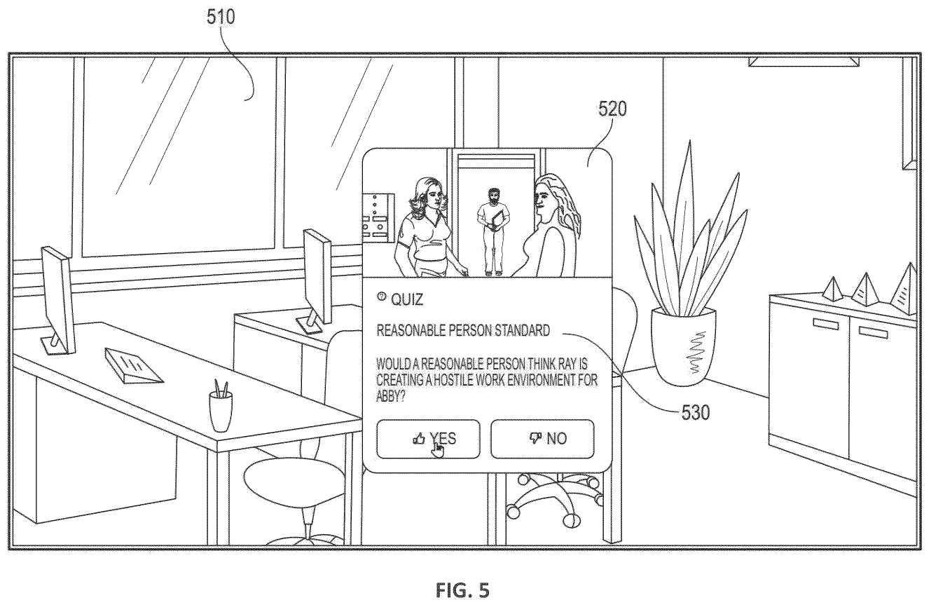

FIG. 5 is a diagram illustrating one example embodiment of a UI for a training module being presented to an employee with custom organization elements incorporating custom organization content.

Within the example embodiment, a screenshot of a UI is presented for a training module in the process of being completed by an employee of an organization. A background image 510 is displayed for this portion of the training module, and within the primary window in the center of the UI, a scenario video 520 and a scenario quiz 530 are displayed. The background image 510 is a custom organization element which may be filled in with custom organization content that is specific to the organization. The custom organization element may specify that the content to be used is to be specific to the type of organization, or the industry to which the organization belongs. In some cases, the background image 510 being used may be one of multiple background images which the organization can select from, or the training platform may be configured to automatically select a background image 510 for the organization based on the type of organization or industry.

The scenario video 520 displayed may also be a custom organization element which has been filled in with custom organization content. In this case, one or more of the people presented within the video may visually depict employees of the organization, with the video itself being dynamically and automatically generated to include the visual likenesses of employees within the organization as custom organization content. Such a video may be, e.g., a “deepfake” video where the employees being depicted have provided their opt-in consent within the training platform or within the organization to being included in the video. Thus, in this instance, the employee Ray within the scenario quiz 530 is visually shown in the scenario video 520, and the employee Abby within the scenario quiz 530 is also visually shown in the scenario video 520, such that the names and likenesses match up.

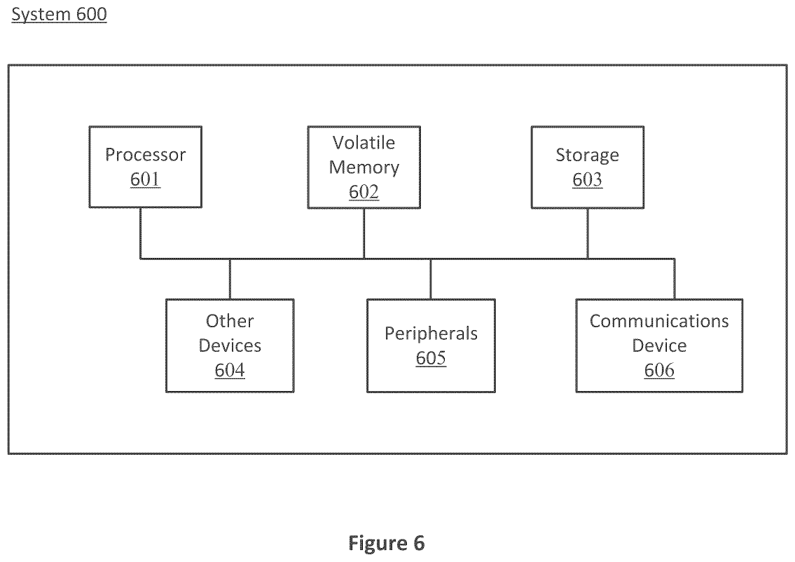

FIG. 6 is a diagram illustrating an exemplary computer that may perform processing in some embodiments. Exemplary computer 600 may perform operations consistent with some embodiments. The architecture of computer 600 is exemplary. Computers can be implemented in a variety of other ways. A wide variety of computers can be used in accordance with the embodiments herein.

Processor 601 may perform computing functions such as running computer programs. The volatile memory 602 may provide temporary storage of data for the processor 601. RAM is one kind of volatile memory. Volatile memory typically requires power to maintain its stored information. Storage 603 provides computer storage for data, instructions, and/or arbitrary information. Non-volatile memory, which can preserve data even when not powered and including disks and flash memory, is an example of storage. Storage 603 may be organized as a file system, database, or in other ways. Data, instructions, and information may be loaded from storage 603 into volatile memory 602 for processing by the processor 601.

The computer 600 may include peripherals 605. Peripherals 605 may include input peripherals such as a keyboard, mouse, trackball, video camera, microphone, and other input devices. Peripherals 605 may also include output devices such as a display. Peripherals 605 may include removable media devices such as CD-R and DVD-R recorders/players. Communications device 606 may connect the computer 100 to an external medium. For example, communications device 606 may take the form of a network adapter that provides communications to a network. A computer 600 may also include a variety of other devices 604. The various components of the computer 600 may be connected by a connection medium such as a bus, crossbar, or network.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A method for providing dynamic content personalization within a training platform, comprising:
connecting a client device to a training platform, the client device being associated with an employee of an organization;
determining that custom organization content is associated with the organization within the training platform;
receiving at least a subset of the custom organization content and at least a content type for each piece of custom organization content; and
presenting, to the client device, a user interface (UI) for a training module selected for employees of the organization, the UI comprising one or more custom organization elements alongside a plurality of training elements, at least a subset of the custom organization elements incorporating one or more pieces of the custom organization content.

2. The method of claim 1, wherein each of the custom organization elements comprise information on one or more content types to be incorporated into the custom organization element.

3. The method of claim 1, wherein at least one piece of the custom organization content relates to an industry classification for the organization.

4. The method of claim 1, wherein at least one piece of the custom organization content relates to one or more of: an organization logo, an organization background image, an industry background image, and an organization color scheme.

5. The method of claim 1, wherein at least one piece of the custom organization content relates to an organizational structure for the employees of the organization.

6. The method of claim 1, wherein at least a subset of the custom organization content relates to one or more of: names, titles, and departments of the employees within the organization.

7. The method of claim 1, wherein at least a subset of the custom organization elements relate to backgrounds for one or more video presentations, wherein the backgrounds incorporate one or more industry or organization backgrounds as custom organization content.

8. The method of claim 1, wherein at least a subset of the custom organization elements relate to a playback speed of audio narration within the training module.

9. The method of claim 1, wherein at least a subset of the custom organization elements relate to one or more of a custom narrator or a vocal tone of audio narration within the training module.

10. The method of claim 1, wherein connecting the client device to the training platform comprises authorizing and authenticating the client device within the training platform.

11. The method of claim 1, wherein at least a subset of the custom organization elements comprise names used within training scenarios, where names of coworkers of the employee are incorporated into those custom organization elements.

12. The method of claim 1, wherein at least a subset of the custom organization elements comprise images of people used within training scenarios, where images of coworkers of the employee are incorporated into those custom organization elements.

13. A communication system comprising one or more processors configured to perform the operations of:
connecting a client device to a training platform, the client device being associated with an employee of an organization;
determining that custom organization content is associated with the organization within the training platform;
receiving at least a subset of the custom organization content and at least a content type for each piece of custom organization content; and
presenting, to the client device, a user interface (UI) for a training module selected for employees of the organization, the UI comprising one or more custom organization elements alongside a plurality of training elements, at least a subset of the custom organization elements incorporating one or more pieces of the custom organization content.

14. The communication system of claim 13, wherein the one or more processors are further configured to perform the operations of:
connecting to a payroll provider for the organization;
verifying one or more permissions with the payroll provider to receive custom organization content related to the organization; and
receiving custom organization content related to the organization from the payroll provider.

15. The communication system of claim 13, wherein one or more of the steps are performed using machine learning (ML) techniques.

16. The communication system of claim 13, wherein at least a subset of the custom organization elements relate to dynamically generated video, where a name, likeness, voice, or other identifying content of an employee may be used within the dynamically generated video.

17. The communication system of claim 13, wherein the custom organization content comprises one or more of: text, audio, images, video, VR/AR content, and interactive elements.

18. The communication system of claim 13, wherein using one or more pieces of custom organization content within the video module comprises verifying that an employee associated with that content has given opt-in consent for the custom organization content to be used.

19. The communication system of claim 13, wherein at least a subset of the custom organization elements comprises custom training scenarios, where custom organization content relating to custom training scenarios for the organization are incorporated into the custom organization elements.

20. A non-transitory computer-readable medium containing instructions for providing dynamic content personalization within a training platform, comprising:
instructions for connecting a client device to a training platform, the client device being associated with an employee of an organization;
instructions for determining that custom organization content is associated with the organization within the training platform;
instructions for receiving at least a subset of the custom organization content and at least a content type for each piece of custom organization content; and
instructions for presenting, to the client device, a user interface (UI) for a training module selected for employees of the organization, the UI comprising one or more custom organization elements alongside a plurality of training elements, at least a subset of the custom organization elements incorporating one or more pieces of the custom organization content.
